(19) United States
(12) Patent Application Publication
(10) Pub. No.: US 2008/0191596 A1
(43) Pub. Date: Aug. 14, 2008

(54) DEVICE FOR PRODUCING ELECTRICAL DISCHARGES IN AN AQUEOUS MEDIUM

(76) Inventor: David Leo King, High Springs, FL (US)

Correspondence Address: DAVID L. KING, SR., 5131 N.E. COUNTY ROAD 340, HIGH SPRINGS, FL, 32643, US

(21) Appl. No.: 11/674,824

(22) Filed: Feb. 14, 2007

(51) Int. Cl. H01J 13/04

(52) U.S. Cl. 313/165

(57) ABSTRACT

A device for producing electrical discharges in an aqueous medium, the device has a first electrode 3 and a second electrode 4, where each electrode 3, 4 is made of a metal alloy 5 and each has an electrode tip 3C, 4C integral or otherwise affixed to said electrode 3, 4. Each tip 3C, 4C is made of a metal alloy and at least the outer surface of such tips includes a percentage of gold or platinum. Preferably the entire tip 3C, 4C portion is made of an alloy 5 having between 0.02 to 20 percent weight percent gold or platinum. The tip metal alloy 5 preferably has a base composition of steel, more preferably a base composition having either at least 4 percent cobalt or at least 4 percent nickel in combination with the small amount of gold or platinum. The use of gold or platinum provides exceptional electrical conductivity, but improves the ductility of the tip material such that the explosive and corrosive effects of the high voltage plasma discharges in the acoustic shock waves are greatly diminished.

### TECHNICAL FIELD

The present invention relates to improved materials for electrodes for use in electrode assemblies in acoustic shock wave generating devices such as lithotripters.

### BACKGROUND OF THE INVENTION

Acoustic shock waves are created when a high voltage discharge spark passes between two coaxially aligned opposing electrode tips. In the presence of a fluid the energy is released by the spark which flashes the water to steam creating an acoustic wave wherein a series of such waves can pass through tissue to break up concrements within the body.

Preferably, the fluid around the electrode tips is a saline solution to enhance electro conductivity. In some electrode assemblies the fluid surrounding the tips is also charged with carbide particles to further increase conductivity. Such a device is described in U.S. Pat. No. 6,113,560 entitled “Method and Device For Generating Shock Waves For Medical Therapy, Particularly For Electro-Hydraulic Lithotripsy” issued Sep. 5, 2000.

As can easily be appreciated the spark generated by the voltage discharge can create a large amount of heat and explosive force which tends to burn and erode the tips of the opposing electrode conductors. As the tips burn, the spark gap distance increases resulting in even higher voltages to create a discharge. At some point this dramatically degrades the shock wave pulses generated rendering the electrode assembly non effective. This situation can occur in a very quick time meaning the replacement of the electrode assemblies is done after every second, third or fourth patient procedure. While these devices are adapted for rapid change over or replacement it is also noted that each assembly can cost as much as several hundred dollars.

Accordingly, the device described in U.S. Pat. No. 6,113,560 has been touted as having a longer time of useful capacity and better gap distance maintenance than other similar devices. While this is true, the replacement cost is offset by the high end price demanded for the product.

In U.S. Pat. No. 6,972,116 B2 a device for producing electrical discharges in an aqueous medium has a first electrode and a second electrode made of a superalloy having a cobalt content of greater than 8% by weight or optionally a nickel content of greater than 8% by weight. A high electrical voltage is applied to the electrodes to produce a voltage discharge into the medium that creates a pressure wave in the medium. The electrodes of this prior art device exhibited high thermal shock resistance during discharge thereby reducing tip burnout, when compared to the previously used steel no. 1.2000-1.3000 which had good machinability for making tip configurations.

In U.S. Pat. No. 6,849,994 granted Feb. 1, 2005 in a patent entitled “Electrode Assembly for Lithotripters” the same owner of the U.S. Pat. No. 6,113,560 patent describes the need for refurbishing electrode assemblies used in lithotripters by providing easily replaceable tips. In that patent the inventors noted that a prior art electrode with an insulating layer required the insulating layer to be machined off the inner conductor prior to replacement of the discharge tip and then reapplication of the insulating layer, presumably by remolding the plastic insulating layer over the inner conductor. Naturally this was a labor intensive practice that was cost prohibitive. It was their idea to provide threaded replacement tips that could easily been replaced when burnt to refurbish a used electrode assembly. This, they argued, could greatly reduce replacement cost.

The present invention discloses a new improved alloy that can be used to make a full electrode, or a replaceable electrode tip or can be used as an outer sheathing layer or coating for the tip of an electrode.

The improved alloy of the present invention further enhances both the erosion resistance and the corrosion resistance while increasing the electrical conductivity of the electrode tips, greatly delaying the tip burnout rate and thus increasing the useful tip life when compared to the above mentioned prior art electrodes.

### SUMMARY OF THE INVENTION

A device for producing electrical discharges in an aqueous medium, the device has a first electrode and a second electrode, where each electrode is made of a metal alloy and each has an electrode tip integral or otherwise affixed to said electrode. Each tip is made of a metal alloy and at least the outer surface of such tips includes a percentage of gold or platinum. Preferably the entire tip portion is made of an alloy having between 0.02 to 20 percent weight percent gold or platinum. The tip metal alloy preferably has a base composition of steel, more preferably a base composition having either at least 4 percent cobalt or at least 4 percent nickel in combination with the small amount of gold or platinum. The use of gold or platinum provides exceptional electrical conductivity, but improves the ductility of the tip material such that the explosive and corrosive effects of the high voltage plasma discharges in the acoustic shock waves are greatly diminished.

### Definitions

A “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nano-seconds (ns) up to some milli-seconds (ms). Very fast pressure pulses are called shock waves. Shock waves used in medical applications do have amplitudes above 0.1 MPa and rise times of the amplitude are below 100 ns. The duration of a shock wave is typically below 1-3 micro-seconds (μs) for the positive part of a cycle and typically above some micro-seconds for the negative part of a cycle.

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different way, for example: A focused wave will become divergent once it has passed through the focal point. Spherical waves are also included in this definition of divergent waves and have wave fronts with divergent characteristics.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “curved emitter” is an emitter having a curved reflecting (or focusing) or emitting surface and includes, but is not limited to, emitters having ellipsoidal, parabolic, quasi parabolic (general paraboloid) or spherical reflector/reflecting or emitting elements. Curved emitters having a curved reflecting or focusing element generally produce waves having focused wave fronts, while curved emitters having a curved emitting surfaces generally produce wave having divergent wave fronts.

### BRIEF DESCRIPTION OF THE DRAWINGS

The invention will be described by way of example and with reference to the accompanying drawings in which:

FIGS. 1A, 1B, 1C are views of an exemplary electrode assembly according to the present invention.

FIG. 1A is a perspective view of an assembled electrode.

FIG. 1B is a cross sectional view of the assembled electrode of FIG. 1A.

FIG. 1C is an exploded perspective view of the various components of the electrode assembly of FIG. 1A.

FIG. 2 is a plan view of the inner electrode with an integral electrode tip made in accordance with the present invention.

FIG. 3 is a third embodiment inner electrode with an integral electrode tip sheathed in the alloy material of the present invention.

FIG. 4 is an exploded view of an alternative embodiment inner electrode with a replaceable electrode tip.

FIG. 5 is a plan view of the outer electrode made in accordance with the alloy material of the present invention.

### DETAILED DESCRIPTION OF THE INVENTION

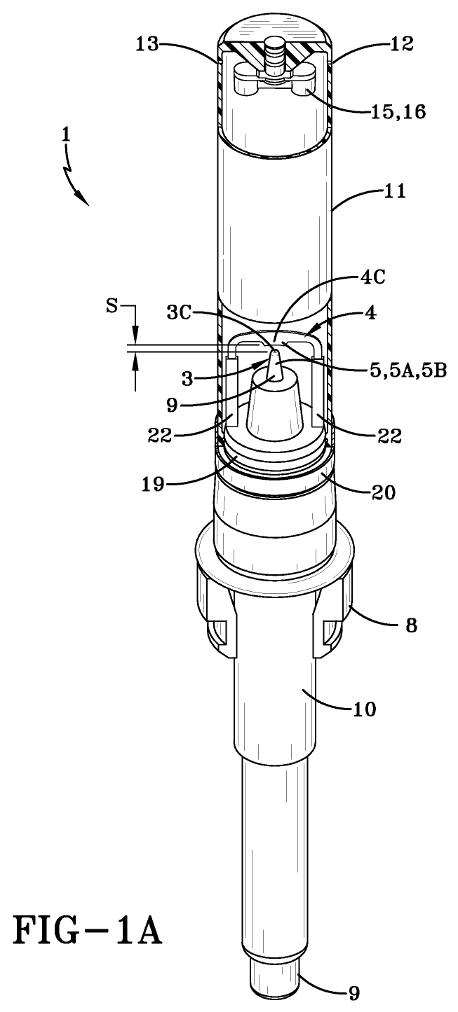

With reference to FIGS. 1A, 1B, 1C an exemplary electrode assembly 1 is shown having two electrodes 3, 4. The electrode 3 is connected to an inner conductor 9 embedded in a plastic installation body 8 that has been insert molded around an electrical conductor 9. The electrode 4 is electrically connected to a tubular outer conductor 10. The outer electrode 4 has a pair of legs 4A and 4B connected by a transverse tip portion 4C which has the electrode projecting toward the electrode tip 3C. When new this distance is set at a spark gap distance S. The space around the electrodes 3, 4 is surrounded by a sleeve 11 which is permeable to shock waves and has two holes 12 and 13, each of several hundred micrometers in diameter. The sleeve 11 is filled with degassed water 14 that has some level of salinity and has a resistivity of about 2000 ohms by cm². Particles are placed in the container 16 retained in the sleeve 11, the container 16 holds carbide particles 15 that disperse through two small holes 17, 18 in the container 16 during a shock wave activation. Once activated these particles 15 stay suspended in the saline water 14 and help provide a longer life and higher conductivity of the water 14 for use in the electrode 1. As shown the sleeve 11 sits over the plastic insulator body 8 which has several hose barb circular seal connections 19 such that the sleeve 11 when pressed over the insulator body 8 makes a gripping attachment. To provide a water tight seal, a metal ring 20 is then pressed over the sleeve 11 and the insulator body 8 overlying this region of barb seal connectors 19 making an extremely tight sealed fit. When the electrode 1 has been used to the point that the tips 3C and 4C are sufficiently burnt that the gap S cannot be maintained between the two electrodes 3 and 4 the entire electrode assembly 1 is generally disposed of. This exemplary device as described above is similar to and is further described in U.S. Pat. No. 6,113,560 which is incorporated herein by reference in its entirety.

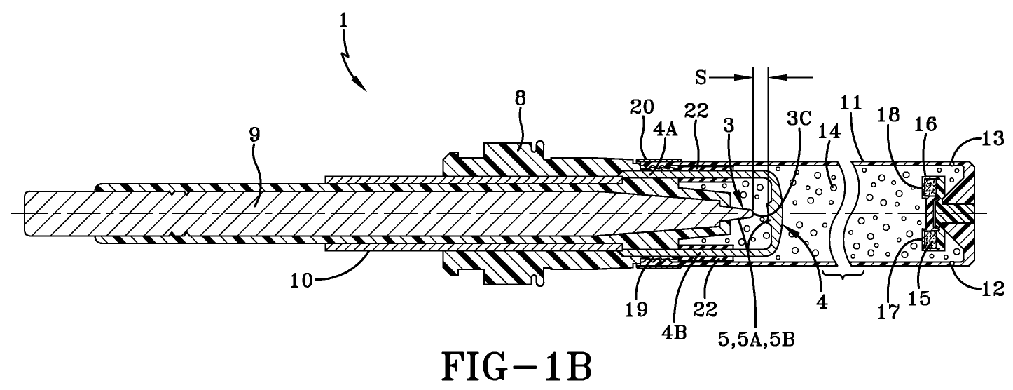

With reference to FIG. 2 the electrical inner conductor 9 with an electrode tip 3C made in accordance to the present invention is shown. As shown a conductor 9 has an electrode tip 3C wherein the electrode tip 3C is a conical shape having approximately a 10 degree angle of slope and measuring back to a shoulder for example the electrode tip extends a distance X from the shoulder to the electrode tip 3C.

It is this tip portion 3C that erodes and burns during the electrical discharges created during use. Even the use of superalloy materials having high corrosion and erosion resistance such as those described in U.S. Pat. No. 6,972,116 B2 having at least 8% cobalt or 8% nickel as a base material are rendered useless after 2 to 4 patient's treatments.

The present invention employs the use of highly conductive precious metals 5 such as gold or platinum at the tip region on or in an alloy of a base metal such as steel or an alloy of metals having at least 4% nickel or cobalt.

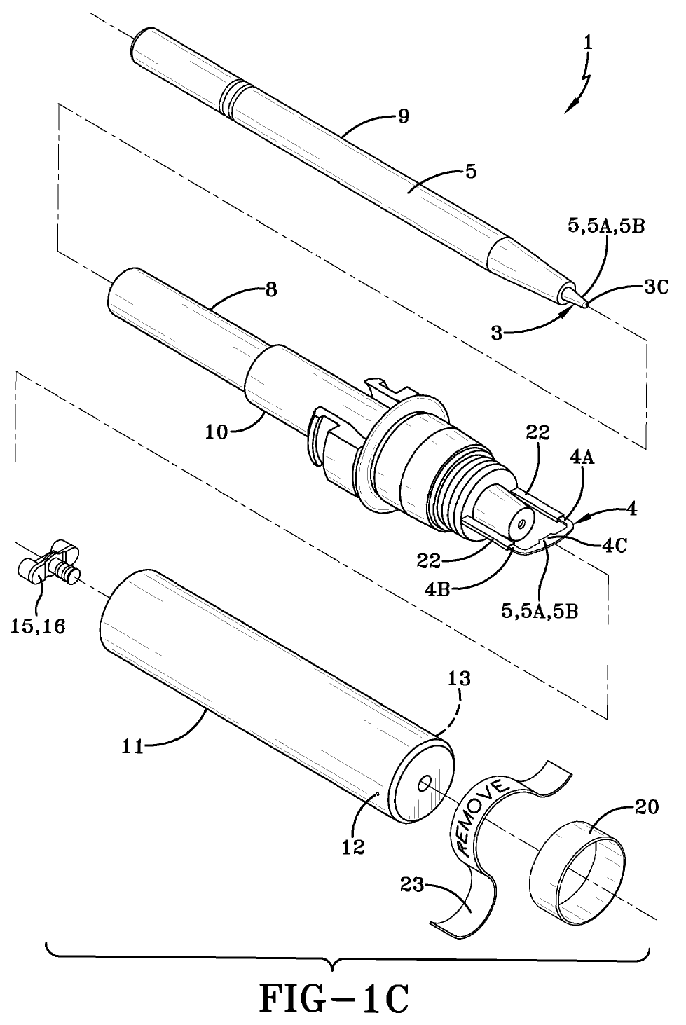

In one embodiment shown in FIG. 3, the precious metal 5 is adhered to the tip 3C in a plating or brazing process to create a sheathed tip 5A having a high gold or platinum content of a sheath thickness of greater than 0.0005 of an inch more preferably about 0.025 of an inch. This brazing or plating alloy 5B has an alloy content of from 1% to 77% gold, from 1-59% palladium and from 20% to about 61% of metal selected from the group consisting of nickel, chromium, cobalt and mixtures thereof.

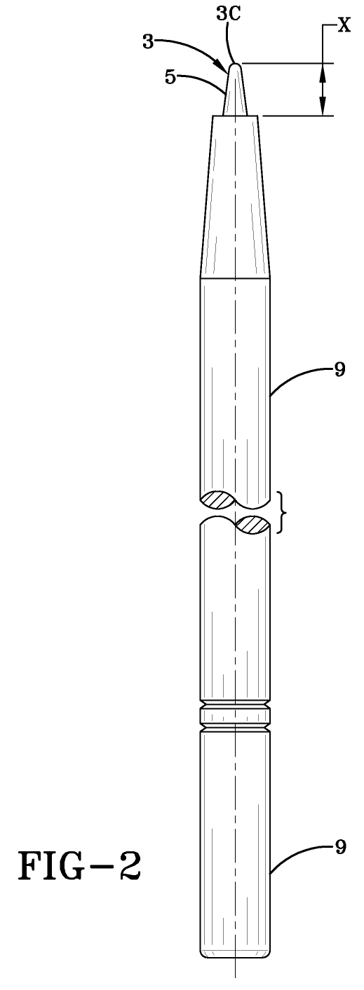

As shown in FIG. 4 this brazing alloy 5B can be used to braze a tip 3C to a conductor 9 wherein the conductor 9 is made of a base metal steel such as was previously used in the prior art made of steel 1.2000-1.3000 or a superalloy base metal having a cobalt or nickel content greater than 4%. The tip 3C alternatively is made of an alloy having 0.2 to 20% percent weight percent of a precious metal 5 of either gold or platinum. Alternatively the tip 3C with a precious metal 5 can be threaded into the conductor 9 as shown in FIG. 4 and adapted for rapid replacement similar to that described in U.S. Pat. No. 6,849,944. In either embodiment the resultant tip 3C using gold or platinum is far less brittle having superior conductivity with the unexpected benefit of being much slower to erode due to the reduction of the crystalline particles that are brittle and easily fractured during the explosive conditions found in shock wave generations.

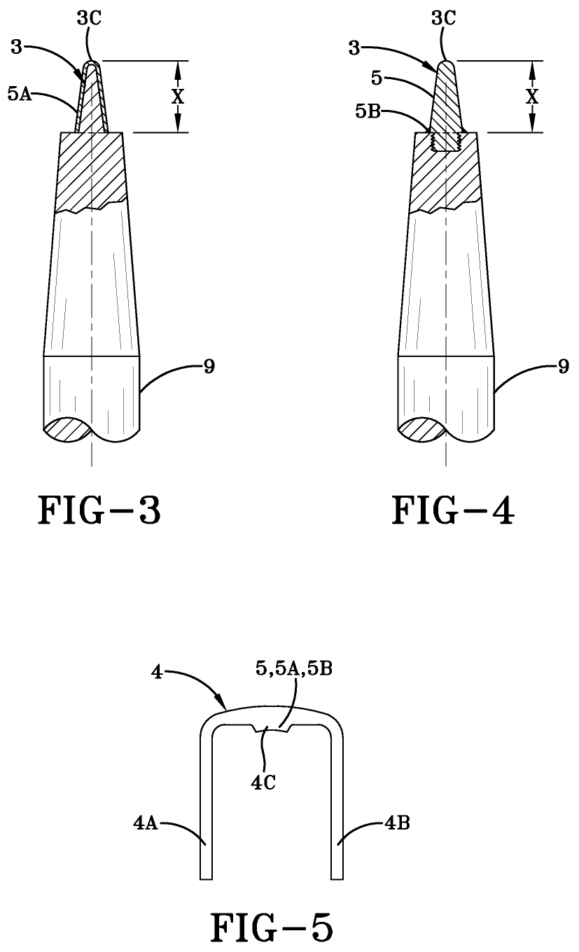

While it is possible to manufacture the entire electrode 3 integral to the conductor 9 and the conductor out of an alloy using 0.2 to 20% of precious metal 5 of either gold Au or platinum as shown in FIG. 2, it is believed to be more cost efficient to provide only the tip 3 portion made of this alloy having the precious metal 5 of gold or platinum whether the tips 3 are threaded and brazed as in FIG. 4 or otherwise attached to the conductor or to provide the tip 3C plated or sheathed in an alloy 5A having between 1 and 77% gold in a thickness of 0.001 inch or greater preferably about 0.025 inch thickness, the thicker the plating the longer the expected life of the electrode as illustrated in FIG. 3. In addition the outer electrode 4 as shown in FIG. 5 at least in the transverse portion 4C including the tip region 4C can be made of the alloy material 5 or sheathed 5A with a plating of the brazing alloy 5B material so that both electrode tips 3C and 4C have the beneficial aspects of the gold or platinum alloy.

In one embodiment of the present invention used electrodes 3 or 4 can be repaired by disassembling the electrode assembly recutting or reshaping the burnt tip 3C or 4C and sheathing the recut or reshaped tip 3C or 4C with an outer sheath 5A using the gold filled brazing alloy 5B described above.

Testing of this gold brazing alloy 5B has shown superior high temperature survival in applications for gas turbine engines as is taught in U.S. Pat. No. 3,148,053 however, its use in an immersed electrode device for this generation of acoustic shock waves has never been contemplated.

The method of making a welded joint or sheath plating of this alloy 5B is repeated below and is from U.S. Pat. No. 3,148,053 which is incorporated herein by reference in its entirety.

The preferred brazing alloy 5B contains:
From about 77% to about 1% gold
From about 59% to about 1% palladium and
From about 55% to about 20% of any of the metals nickel or chromium, or mixtures thereof.

Specific alloy compositions 5B which have been found particularly useful in the production of brazed heavy articles include the following:
From about 55% to about 45% gold
From about 30% to about 20% palladium
From about 30% to about 20% nickel and
From 0% to about 10% chromium
the alloy
From about 40% to about 30% gold
From about 40% to about 30% palladium
From about 35% to about 25% nickel with from 0% to about 10% chromium
the alloy
From about 25% to about 15% gold
From about 50% to about 40% palladium
From about 40% to about 30% nickel and
From 0% to about 10% chromium
the alloy
From about 65% to about 55% gold
From about 20% to about 10% palladium
From about 30% to about 20% nickel and
From 0% to about 10% chromium

Alloys which have been found to be particularly useful in the brazing of light-weight articles include the following:
From about 45% to about 35% gold
From about 30% to about 20% palladium
From about 40% to about 30% nickel and
From 0% to about 10% chromium
the alloy
From about 35% to about 25% gold
From about 39% to about 29% palladium
From about 41% to about 31% nickel and
From 0% to about 10% chromium

It will be understood by those skilled in the art that this alloy can substitute gold with platinum or a combination of gold and platinum and contain trace impurities such as carbon, manganese, silicon, etc., which are unavoidable even with the purest starting materials and best techniques.

The brazing alloys 5B of this invention provide a convenient system for step brazing. In step brazing, two pieces are brazed together at a high temperature, 2200 F, using a high melting point alloy. The solidus, that is, the point at which the alloy starts to melt, for this alloy is about 2150 F and the liquidus, or the point where the alloy is completely melted, is about 2175 F. The composite piece is then removed from the furnace in which it was brazed. A third piece and the necessary brazing alloy are positioned next to the other two united pieces. The piece is then placed in the furnace again and brazed at a lower temperature of 2150 f. The solidus for this alloy is about 2080 F and the liquidus to about 2125 F. Since the second brazing step is carried out at a temperature below the liquidus of the alloy with which the first joint was brazed, the first braze will not be remelted. The article is then removed for a second time from the furnace and the procedure repeated again. This alloy has a solidus of about 2015 F and a liquidus of about 2080 F. A fourth piece is thus brazed to this composite structure using a temperature of 2100 F without remelting either of the first two braze joints. The procedure is repeated for a fourth time using a braze temperature of 1975 F. The solidus of this alloy is about 1875 F and the liquidus is about 1950 F. Step brazing is used where it is difficult or impossible to hold all the elements of an assembly in their proper positions at one time.

The brazing alloy 5B of this invention finds valuable application in the joining together of similar or dissimilar base materials. This alloy 5B is particularly useful in joining together high temperature metals and alloys, for example, stainless steels, nickel, cobalt, zirconium, tantalum, titanium, chromium, vanadium and their high temperature alloys; low, medium, and high carbon steels, alloy tool steels, sintered carbides; electronic tube materials, such as tungsten, molybdenum and cadmium, etc.

A flux can be used if desired. Conventional fluxes typical of those which can be used include chlorides, fluorides, borates, borax, boric acid, fluoborates, wetting agents, etc.

The base materials brazed with this alloy 5B should be cleaned and prepared by conventional physical or chemical methods before brazing. It is not necessary to plate the base materials before brazing, as excellent joints are prepared without this procedure, but plating can be used if so desired.

The brazing foils of this invention are adapted to be used in vacuum, inert or reducing atmosphere furnaces. The brazing alloy of this invention finds valuable application where vacuum is used in the brazing furnaces since all three components of this alloy have relatively low vapor pressures. At 2250 F the vapor pressure of gold is 0.0002 mm. Hg, palladium is 0.000045 mm Hg, nickel is 0.00006 mm Hg and chromium is 0.019 mm Hg. A brazing operation employing this brazing alloy can be carried out using any of the conventional brazing processes such as torch, arc, furnace, induction, resistance, dip, block and flow. The alloy of this invention is ductile enough to be produced and used in foil, wire or other shaped forms which are the preferred forms; however, it can be used as a powder if desired.

Joints prepared using the braze alloy of this invention can be subjected to continuous operating temperatures up to 1900 F and above, without detrimental result.

The alloy of this invention does not contain secondary brittle phases. Therefore, brazed joints prepared using this alloy are relatively homogeneous across their entire cross-section having relative uniform properties throughout.

Very precise control of proportions of ingredients in this alloy is not necessary since slight variations in composition do not materially affect the physical properties of this alloy. This permits obtaining accurate, reproducible results from one batch to another of brazing alloy 5B. Any specific composition of alloy of this invention melts over a narrow temperature range.

In preparing objects from the alloy of this invention, it is possible to use any desired heating rate or section size. The preset clearance between the articles being brazed need not be carefully controlled. Preset clearances from 0.000 in to 0.125 in, and larger, have been used with success. In the instance where a 0.0000 in preset clearance is used, the pieces to be brazed are clamped together and the braze alloy 5B is placed over the joint to be brazed. The braze alloy 5B will erode the base metals at the joint during brazing and, thus, work its way all through the joint.

This brazing alloy 5B is extremely resistant to corrosion by hot gases, moist conditions or corrosive liquids.

The linear coefficient of thermal expansion of this brazing alloy 5B is close to that of most high temperature base metals. Most high temperature base metals have a coefficient of about 7.0 to 9.0×10⁻⁶ in/in/F, whereas this alloy has a coefficient of about 8.6×10⁻⁶ in/in/F. The closeness of these coefficients reduces the danger of cracking the joint or adjacent the preferred base metal during temperature cycling.

Similarly using typically lower amounts of gold or platinum in combination with a steel or steel alloy or superalloy of a cobalt or nickel content of greater than 4% has been shown to improve the performance of the base metal when used in high temperature corrosive environment. This was found particularly true if the alloy contained niobium containing alloys or other high temperature alloys as is taught in U.S. Pat. No. 5,374,393 which is incorporated herein by reference in its entirety. Some representative alloys containing a base metal of either nickel or cobalt was established and is provided herein wherein the content is of at least greater than 4% have been provided for reference.

In a preferred embodiment, alloys based on a root alloy of composition 65.6 wt % Ni—18.2 wt % Cr—5.9 wt % Al—5.8 wt % Ti—4.3 wt % Mo—0.1 wt % Y—0.1% C with increasing Au content from 0.02 wt % to 20 wt % Au were prepared by arc melting these materials together in a water cooled copper hearth under an atmosphere of argon, said melting process being repeated until an acceptable degree of homogeneity is achieved. In this preferred embodiment, an alloy consisting essentially of 62.3 wt % Ni—17.3 wt % Cr—5.6 wt % Al—5.5 wt % Ti—4.1 wt % Mo—0.1 wt % Y—0.1 wt % C—5 wt % Au, had a 13% lower hardness, as measured by the Knoop method, than the root alloy exposed to the same conditions. All of these alloys containing Au were heated in air at 1000 degrees centigrade and their average Knoop hardness, was found to be 9% lower than similarly-prepared samples of the commercial Waspaloy alloy that were exposed to the same conditions. Such a decrease in hardness connotes a concomitant increase in desirable ductility. The beneficial effect of Au additions on reducing the Knoop hardness of the root alloy (65.6 wt % Ni—18.2 wt % Cr—5.9 wt % Al—5.8 wt % Ti—4.3 wt % Mo—0.1 wt % Y—0.1 wt % C) was found to extend over the range of composition from essentially (52 to 66) wt % Ni—(14.5 to 18.5) wt % Cr—(4.6 to 6) wt % Al—(4.5 to 6) wt % Ti—(3.4 to 4.4) wt % Mo—(0.08 to 0.1) wt % Y—(0.02 to 0.1) wt % C—(0.02 to 20) wt % Au.

In another preferred embodiment, alloys based on the commercial alloy designated Incoloy 800 (nominal composition: 45 wt % Ni—32 wt % Fe—21 wt % Cr—0.4 wt % Al—0.4 wt % Ti—0.75 wt % Mn—0.4 wt % Cu—0.05 wt % C) with increasing Au content from 0.02 wt % to 20 wt % Au were prepared by arc melting these materials together in a water cooled copper hearth under an atmosphere of argon, said melting process being repeated until an acceptable degree of homogeneity is achieved. In this preferred embodiment, an alloy consisting essentially of 40.5 wt % Ni—28.8 wt % Fe—18.9 wt % Cr—0.38 wt % Al—0.38 wt % Ti—0.7 wt % Mn—0.3 wt % Cu—0.04 wt % C—10 wt % Au, the oxidation rate, measured in milligrams of weight gained per square centimeter of surface area per hour of exposure in air at 1000 degrees centigrade, was found to be 0.067. All of these alloys containing Au were heated in air at 1000 degrees centigrade and their average oxidation rate, was found to be 0.074 over the range of Au additions from 0.02 to 20. Similarly-prepared samples of the commercial alloy that were exposed to the same conditions showed an average oxidation rate of 0.084. It is thus seen that the presence of the gold significantly reduced the overall oxidation rate. The beneficial effect of Au additions on reducing the oxidation rate of Incoloy 800 was found to extend over the range of composition from essentially (36 to 45) wt % Ni—(25 to 32) wt % Fe—(16 to 21) wt % Cr—(0.3 to 0.4) wt % Al—(0.3 to 0.4) wt % Ti—(0.6 to 0.8) wt % Mn—(0.3 to 0.4) wt % Cu—(0.02 to 0.05) wt % C—(0.02 to 20) wt % Au.

In still another preferred embodiment, alloys based on the commercial alloy designated B1900+Hf (nominal composition: 63.4 wt % Ni—10 wt % Co—8 wt % Cr—6 wt % Al—1 wt % Ti—4.25 wt % Ta—6 wt % Mo—1.15 wt % Hf—0.08 wt % Zr—0.015 wt % B—0.11 wt % C) with increasing Au content from 0.02 wt % to 20 wt % Au were prepared by arc melting these materials together in a water cooled copper hearth under an atmosphere of argon, said melting process being repeated until an acceptable degree of homogeneity is achieved. In this preferred embodiment, an alloy consisting essentially of 57.07 wt % Ni—9 wt % Co—7.2 wt % Cr—5.4 wt % Al—0.9 wt % Ti—3.82 wt % Ta—5.4 wt % Mo—1.04 wt % Hf—0.07 wt % Zr—0.01 wt % B—0.09 wt % C—10 wt % Au, the oxidation rate, measured in milligrams of weight gained per square centimeter of surface area per hour of exposure in air at 1000 degrees centigrade, was found to be 0.031. All of these alloys containing Au were heated in air at 1000 degrees centigrade and their average oxidation rate, was found to be 0.033 over the range of Au additions from 0.02 to 20. Similarly-prepared samples of the commercial alloy that were exposed to the same conditions showed an average oxidation rate of 0.039. It is thus seen that the presence of the gold significantly reduced the overall oxidation rate. The beneficial effect of Au additions on reducing the oxidation rate of B1900+Hf was found to extend over the range of composition from essentially (50.7 to 63.4) wt % Ni—(8 to 10) wt % Co—(6.4 to 8) wt % Cr—(4.8 to 6) wt % Al—(0.8 to 1) wt % Ti—(3.4 to 4.25) wt % Ta—(4.8 to 6) wt % Mo—(0.92 to 1.15) wt % Hf—(0.06 to 0.06) wt % Zr—(0.012 to 0.015) wt % B—(0.02 to 0.11) wt % C—(0.02 to 20) wt % Au. As can be seen the testing verifies the improved characteristic for oxidation and corrosion resistance in those test samples. This was remarkable in that a benefit was achieved using 0.2% weight percent.

In another preferred embodiment, alloys based on the commercial alloy designated Haynes 188 (nominal composition: 22 wt % Ni—3 wt % Fe—37.2 wt % Co—22 wt % Cr—14 wt % W—1.25 wt % Mn—0.35 wt % Si—0.075 wt % La—0.015 wt % B—0.1 wt % C) with increasing Au content from 0.02 wt % to 20 wt % Au were prepared by arc melting these materials together in a water cooled copper hearth under an atmosphere of argon, said melting process being repeated until an acceptable degree of homogeneity is achieved. In this preferred embodiment, an alloy consisting essentially of 20.9 wt % Ni—2.85 wt % Fe—35.34 wt % Co—20.9 wt % Cr—13.3 wt % W—1.19 wt % Mn—0.34 wt % Si—0.07 wt % La—0.01 wt % B—0.1 wt % C—5 wt % Au, the oxidation rate, measured in milligrams of weight gained per square centimeter of surface area per hour of exposure in air at 1000 degrees centigrade, was found to be 0.015. All of these alloys containing Au were heated in air at 1000 degrees centigrade and their average oxidation rate, was found to be 0.017 over the range of Au additions from 0.02 to 20. Similarly-prepared samples of the commercial alloy that were exposed to the same conditions showed an average oxidation rate of 0.019. It is thus seen that the presence of the gold significantly reduced the overall oxidation rate. The beneficial effect of Au additions on reducing the oxidation rate of Haynes 188 was found to extend over the range of composition from essentially (17.6 to 22) wt % Ni—(2.4 to 3) wt % Fe—(29.7 to 37.2) wt % Co—(17.6 to 22) wt % Cr—(1.2 to 14) wt % W—(1 to 1.25) wt % Mn—(0.28 to 0.35) wt % Si—(0.06 to 0.075) wt % La—(0.012 to 0.015) wt % B—(0.02 to 0.1) wt % C—(0.02 to 20) wt % Au.

In another preferred embodiment, alloys based on a root alloy of composition 64.7 wt % Ni—8 wt % W—5.5 wt % Co—7.5 wt % Cr—5.8 wt % Al—0.25 wt % Mo—6.75 wt % Ta—0.5 wt % Ti with increasing Au content from 0.02 wt % to 20 wt % Au were prepared by arc melting these materials together in a water cooled copper hearth under an atmosphere of argon, said melting process being repeated until an acceptable degree of homogeneity is achieved. In this preferred embodiment, an alloy consisting essentially of 61.5 wt % Ni—7.6 wt % W—5.2 wt % Co—7.1 wt % Cr—5.5 wt % Al—1.2 wt % Mo—6.4 wt % Ta—0.5 wt % Ti—5 wt % Au, the oxidation rate, measured in milligrams of weight gained per square centimeter of surface area per hour of exposure in air at 1000 degrees centigrade, was found to be 0.253. A similarly-prepared sample of the commercial alloy exposed to the same conditions showed an oxidation rate of 0.287. All of these alloys containing Au were heated in air at 1000 degrees centigrade and their average oxidation rate, was found to be 0.266 over the range of Au additions from 0.02 to 20. It is thus seen that the presence of the gold significantly reduced the overall oxidation rate. The beneficial effect of Au additions on reducing the oxidation rate of the root alloy (64.7 wt % Ni—8 wt % W—5.5 wt % Co—7.5 wt % Cr—5.8 wt % Al—0.25 wt % Mo—6.75 wt % Ta—0.5 wt % Ti) was found to extend over the range of composition from essentially (51.7 to 64.7) wt % Ni—(6.4 to 8) wt % W—(4.4 to 5.5) wt % Co—(6 to 7.5) wt % Cr—(4.6 5.8) wt % Al—(1 to 1.25) wt % Mo—(5.4 to 6.8) wt % Ta—(0.4 to 0.5) wt % Ti—(0.02 to 20) wt % Au.

In another preferred embodiment, alloys based on the commercial alloy designated Inconel 738 (nominal composition: 61.5 wt % Ni—8.5 wt % Co—16 wt % Cr—3.4 wt % Al—3.4 wt % Ti—2.6 wt % W—1.75 wt % Mo—1.75 wt % Ta—0.12 wt % Zr—0.85 wt % Nb—0.012 wt % B—0.13 wt % C) with increasing Au content from 0.02 wt % to 20 wt % Au were prepared by arc melting these materials together in a water cooled copper hearth under an atmosphere of argon, said melting process being repeated until an acceptable degree of homogeneity is achieved. In this preferred embodiment, an alloy consisting essentially of 58.4 wt % Ni—8.1 wt % Co—15.2 wt % Cr—3.2 wt % Al—3.2 wt % Ti—2.5 wt % W—1.7 wt % Mo—1.7 wt % Ta—0.1 wt % Zr—0.8 wt % Nb—0.01 wt % B—0.1 wt % C—5 wt % Au, the oxidation rate, measured in milligrams of weight gained per square centimeter of surface area per hour of exposure in air at 1000 degrees centigrade, was found to be 0.094. All of these alloys containing Au were heated in air at 1000 degrees centigrade and their average oxidation rate, was found to be 0.103 over the range of Au additions from 0.02 to 20. Similarly-prepared samples of the commercial alloy that were exposed to the same conditions showed an average oxidation rate of 0.112. It is thus seen that the presence of the gold significantly reduced the overall oxidation rate. The beneficial effect of Au additions on reducing the oxidation rate of Inconel 738 was found to extend over the range of composition from essentially (42 to 53) wt % Ni—(14.8 to 18.5) wt % Fe—(15.2 to 19) wt % Cr—(0.4 to 0.5) wt % Al—(0.7 to 0.9) wt % Ti—(4 to 5) wt % Nb—(2.4 to 3) wt % Mo—(0.14 to 0.18) wt % Mn—(0.14 to 0.18) wt % Si—(0.12 to 0.15) wt % Cu—(0.02 to 0.04) wt % C—(0.02 to 20) wt % Au.

In another preferred embodiment, alloys based on the commercial alloy designated Haynes 21 (nominal composition: 62.55 wt % Co—2 wt % Ni—27 wt % Cr—1 wt % Fe—6 wt % Mo—0.6 wt % Mn—0.6 wt % Si—0.25 wt % C) with increasing Au content from 0.02 wt % to 20 wt % Au were prepared by arc melting these materials together in a water cooled copper hearth under an atmosphere of argon, said melting process being repeated until an acceptable degree of homogeneity is achieved. In this preferred embodiment, an alloy consisting essentially of 56.3 wt % Co—1.8 wt % Ni—24.3 wt % Cr—0.9 wt % Fe—5.4 wt % Mo—0.54 wt % Mn—0.54 wt % Si—0.22 wt % C—10 wt % Au, the oxidation rate, measured in milligrams of weight gained per square centimeter of surface area per hour of exposure in air at 1000 degrees centigrade, was found to be 0.018. All of these alloys containing Au were heated in air at 1000 degrees centigrade and their average oxidation rate, was found to be 0.021 over the range of Au additions from 0.02 to 20. Similarly-prepared samples of the commercial alloy that were exposed to the same conditions showed an average oxidation rate of 0.31. It is thus seen that the presence of the gold significantly reduced the overall oxidation rate. The beneficial effect of Au additions on reducing the oxidation rate of Haynes 21 was found to extend over the range of composition from essentially (50 to 63) wt % Co—(1.6 to 2) wt % Ni—(21 to 27) wt % Cr—(0.8 to 1) wt % Fe—(4.8 to 6) wt % Mo—(0.48 to 0.6) wt % Mn—(0.48 to 0.6) wt % Si—(0.02 to 0.25) wt % C—(0.02 to 20) wt % Au.

In the process of oxidation, oxygen diffuses into the high temperature superalloy root alloy in advance of the actual metal-oxide interface. This diffusion of oxygen causes the metal to become brittle and susceptible to fracture, which accelerates the oxidation process. The most obvious symptom of this diffusion is a hard “case” about the outer surface of a sample cross-section. It has been found that increasing Au additions dramatically reduce this case. It appears that no more than 10 wt % Au is necessary for this effect to occur, with larger additions only serving to decrease the overall hardness of the resulting alloy. As an example of the ability of Au to reduce the diffusion rate of oxygen, a sample of C-103 exposed to 1000 degrees in air was found to exhibit a “case” 800 Knoop units harder than the interior of the alloy specimen. An equivalent alloy with 10 wt % Au was found to exhibit a virtually uniform hardness cross-section with no detectable case. The addition of Au is thus a process for reducing the diffusion rate of oxygen in high temperature superalloys. This process consists essentially of the addition of 0.02 to 20 wt % Au to a high temperature superalloy root alloy.

It is to be understood that in all of these alloys, there will be present small amounts of elements which exist unavoidably as contaminants and that the presence or absence of these contaminants will not affect the essential composition of the alloys as disclosed in this present invention. For the majority of alloys, the component elements other than Au are preferably selected from the group consisting of Co, Cr, Fe, Al, Ti, Ni, Mo, Nb, Hf, Ag, Mn, Zr, V, Y, C, Cu, Si, La, Ta, W. Additionally this group can be sub-divided into major elements selected from the group consisting of Co, Cr, Fe, Ti, Ni, Mo, Nb, and minor elements selected from the group consisting of Al, Hf, Ag, Mn, Zr, V, Y, C, Cu, Si, La, Ta, W.

It is thus seen that the present invention provides, a process for reducing the oxidation rate of high temperature superalloys, this process consisting essentially of the addition of 0.02 to 20 wt % Au to a high temperature superalloy root alloy. As shown by the embodiments, the root alloy composition is, in each case, the nominal composition of commercial alloys.

In the present application the tip 3 or 4C or the entire electrode 3 or 4 using up to 10% of gold Au would have a uniform hardness without the brittle crystalline effect that induces tip burn out due to explosive erosion. Accordingly the present invention features a use of gold or platinum as a means to improve electrical conductivity in an electrode used in an immersed liquid to generate explosive acoustic shock waves.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A device for producing electrical discharges in an aqueous medium, the device has a first electrode and a second electrode, where each electrode is made of a metal alloy and each electrode has an electrode tip integral or otherwise affixed to said electrode; the device comprising a metal alloy having a percentage of gold or platinum forming or at least covering each electrode tip.

2. The device of claim 1 wherein the outer surface of each tip is sheathed or otherwise plated in a brazing alloy having a percentage of between 1.0% to 77% gold or platinum.

3. The device of claim 1 wherein one or more electrode tips is made of a metal alloy having between 0.02 to 20% weight percent gold or platinum.

4. The device of claim 3 wherein one or more electrode tips are made of a metal alloy having a base composition of steel.

5. The device of claim 3 wherein one or more electrode tips are made of a metal alloy having a base composition having at least 4% cobalt or at least 4% nickel.

6. The device of claim 1 wherein the electrode tip is integral to a electrode conductor.

7. The device of claim 1 wherein the electrode tip is attached to an electrode conductor.

8. The device of claim 7 wherein the electrode tip is brazed to the electrode conductor using a brazing composition.

9. The device of claim 8 wherein the brazing composition has between 1% and 77% by weight gold or platinum.

10. The device of claim 1 wherein at least one electrode tip is made of a metal alloy having between 0.2 and 10% by weight gold or platinum.
